(19) United States
(12) Patent Application Publication
(10) Pub. No.: US 2015/0142975 A1
(43) Pub. Date: May 21, 2015

(54) DISPLAY APPARATUS AND CONTROL METHOD THEREOF

(71) Applicant: SAMSUNG ELECTRONICS CO., LTD., Suwon-si (KR)

(72) Inventors: Jin-woo HONG, Suwon-si (KR); Woo-seok KIM, Bucheon-si (KR); Young-min PARK, Seongnam-si (KR)

(73) Assignee: SAMSUNG ELECTRONICS CO., LTD., Suwon (KR)

(21) Appl. No.: 14/331,467

(22) Filed: Jul. 15, 2014

(30) Foreign Application Priority Data
Nov. 19, 2013 (KR) 10-2013-0140837

(51) Int. Cl. H04L 29/06

(52) U.S. Cl. CPC H04L 63/104
USPC 709/225

(57) ABSTRACT

A display apparatus and method thereof, in which accounts log in when a group account logs in, and an image of an account service for the logged-in accounts is displayed. The apparatus includes a communicator to communicate with a server that offers an account service, a storage to store login information about the accounts and a group account for the accounts, an image processor to process an image of the account service, a displayer to display the processed image, and a controller to make the accounts log in using the login information about the accounts for the group account when the group account logs in, and control the displayer to display an image of the account service for the logged-in accounts. With this, multi-accounts can be quickly logged in/out through simultaneous login/logout of multiple accounts under the condition that multi-login is possible in the display apparatus used by multiple users.

### CROSS-REFERENCE TO RELATED APPLICATION

This application claims priority from Korean Patent Application No. 10-2013-0140837, filed on Nov. 19, 2013 in the Korean Intellectual Property Office, the disclosure of which is incorporated herein by reference.

### BACKGROUND

1. Field

Apparatuses and methods consistent with the exemplary embodiments relate to a display apparatus and a control method thereof, and more particularly, to a display apparatus and a control method thereof, in which login information about a plurality of accounts and a group account corresponding to the plurality of accounts are stored, and when the group account logs in, the plurality of accounts logs in using the login information about the plurality of accounts corresponding to the group account and an image of an account service corresponding to the plurality of logged-in accounts can be displayed.

2. Description of the Related Art

To use an account service, identification (ID)/passwords (PW) of accounts have to be input for login.

At the same time, to use another account, the ID/PS of the another account have to be input for login.

For example, a family of three is watching a smart television (TV). The smart TV offers Internet, so that respective members of the family can use email of an account, social network service (SNS), etc. through their own accounts while watching the smart TV. However, it may be inconvenient for three members of the family to respectively input login information about the accounts so as to activate the accounts. Also, it may be more inconvenient for three members to log in with each account of a same service because of complicated login procedures.

### SUMMARY

One or more exemplary embodiments may provide a display apparatus and a control method thereof, in which login information about a plurality of accounts and a group account corresponding to the plurality of accounts are stored, and when the group account logs in, the plurality of accounts log in using the login information about the plurality of accounts corresponding to the group account and an image of an account service corresponding to the plurality of logged-in accounts can be displayed.

According to an aspect of another exemplary embodiment, there is provided a display apparatus including: a communicator configured to communicate with at least one external server that offers an account service; a storage configured to store login information about a plurality of accounts and a group account corresponding to the plurality of accounts; an image processor configured to process an image of the account service to produce a processed image; a display configured to display the processed image; and a controller configured to make the plurality of accounts log in using the login information about the plurality of accounts corresponding to the group account when the group account logs in to produce a plurality of logged-in accounts, and control the display to display the processed image of the account service corresponding to the plurality of logged-in accounts.

The plurality of accounts may include accounts of users corresponding to the accounts.

The login information may include at least one among an account address, an account identification (ID), an account password, a certification password, and a phone number of a corresponding user.

The controller may control an account to be one of added to, deleted from and edited in the group account.

The controller may select whether to make at least one logged-in another account be logged out in accordance with a user input if the group account logs in while the at least one another account that does not correspond to the group account is logged in.

The controller may add at least one another account to the group account in accordance with a user input if the at least one another account that does not correspond to the group account logs in while the group account is logging in.

The controller may make all accounts of the group account be logged out if the group account is logged out.

The controller may make the plurality of accounts be individually logged out when the group account is logged out.

The controller may select whether to make at least one logged-in another account be logged out in accordance with a user input if the group account logs out while the group account and the at least one another account that does not correspond to the group account are logged in.

The controller may control images of account services corresponding to the plurality of logged-in accounts to be combined and displayed.

According to another aspect of another exemplary embodiment, there is provided a method of controlling a display apparatus, the method including: storing login information about a plurality of accounts and a group account corresponding to the plurality of accounts; making the group account log in; making the plurality of accounts log in using the login information about the plurality of accounts corresponding to the group account; and displaying an image of an account service corresponding to the plurality of logged-in accounts.

The plurality of accounts may include accounts of users corresponding to the accounts.

The login information may include at least one among an account address, an account identification (ID), an account password, a certification password, and a phone number of a corresponding user.

The storing the login information may include controlling an account to be one of added to, deleted from and edited in the group account.

The method may further include selecting whether to make at least one logged-in another account be logged out in accordance with a user input if the group account logs in while the at least one another account that does not correspond to the group account is logged in.

The making the plurality of accounts log in may include adding at least one another account to the group account in accordance with a user input if the at least one another account that does not correspond to the group account logs in while the group account is logged in.

The method may further include making all accounts of the group account be logged out if the group account is logged out.

The method may further include making the plurality of accounts be individually logged out when the group account is logged out.

The method may further include selecting whether to make at least one logged-in another account be logged out in accordance with a user input if the group account logs out while the group account and the at least one another account that does not correspond to the group account are logged in.

The displaying the image may include controlling images of account services corresponding to the plurality of logged-in accounts to be combined and displayed.

One or more exemplary embodiments may provide a method of simultaneously logging-in all accounts of a group account when the group account logs-in and simultaneously logging-out all accounts of the group account when the group account logs-out, and producing account service information for each of the accounts at a time of log-in and log-out and displaying account service status information for each of the accounts where the group account is one of the accounts of the group.

One or more exemplary embodiments may provide a display apparatus, including a processor logging-in all accounts of a group account when the group account logs-in and producing account service information for each of the accounts logged-in; and a display simultaneously displaying the account service information for each of the accounts logged-in. The apparatus may have the account service information depicts a time line showing account log-in order. The apparatus may include a storage storing group account identification and account identification information for each of the accounts of the group, and wherein the processor retrieves the account identification information for each of the accounts of the group when the group account identification is received and collectively logs-in the accounts of the group. The apparatus may, if another account is logged-in when the group account logs-in the processor, responsive to a user selection, one of: logs out the another account and include the another account in the group account and updates the account identification information for each of the accounts of the group with identification information of the another account.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a display apparatus according to an exemplary embodiment;

FIG. 2 is a specific block diagram of display apparatus according to an exemplary embodiment;

FIG. 3 is a control flowchart showing operations of the display apparatus according to an exemplary embodiment;

FIGS. 4 to 6 are specific control flowcharts showing operations of the display apparatus according to an exemplary embodiment; and

FIGS. 7 and 8 show examples of a screen, on which account service information is displayed, in the display apparatus according to an exemplary embodiment.

### DETAILED DESCRIPTION OF EXEMPLARY EMBODIMENTS

Below, exemplary embodiments will be described in detail with reference to accompanying drawings. The exemplary embodiments may be achieved in various forms, and not limited to the following descriptions. For convenience, the following embodiments describe only configurations directly related to the present concept, and the descriptions of the other configurations will be omitted. Further, like numerals refer to like elements throughout.

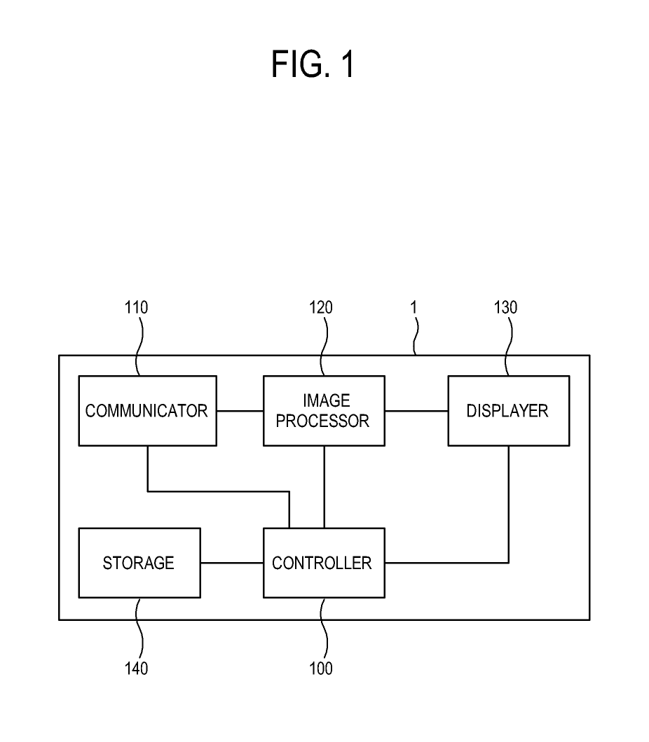

FIG. 1 is a block diagram of a display apparatus 1 according to an exemplary embodiment. In this embodiment, the display apparatus 1 may be achieved by a smart TV, a smart phone, a notebook computer, a personal computer, etc. According to this exemplary embodiment, the display apparatus 1 may include a communicator 110, an image processor 120, a displayer or display 130, an storage 140, and a controller 100.

The communicator 110 receives a signal based on an external input, and transmits it to the image processor 120 or the controller 100. The communicator 110 may receive a signal corresponding to an external input through a wired manner as various external input cables are connected thereto, or may receive a signal through a wireless manner complying with wireless communication standards.

The communicator 110 may include a plurality of connectors (not shown) to which the cables are respectively connected. The communicator 110 may receive a signal based on the connected external input, for example, a broadcasting signal, an image signal, a data signal, etc. based on a high definition multimedia interface, a universal serial bus (USB), a component, or the like standards, or receive communication data through a communication network.

The communicator 110 may include not only an element for receiving a signal/data from the external input, but also various additional elements such as a wireless communication module (not shown) for wireless communication, a tuner (not shown) for selecting the broadcasting signal, etc. in accordance with designs of the display apparatus 1. Besides receiving the signal from an external device, the communicator 110 may transmit information/data/signal of an image processing device to the external device. That is, the communicator 110 is not limited to the function of receiving the signal from the external device, but may be achieved by an interactive interface. The communicator 110 may receive a control signal for selecting a user interface (UI) from a plurality of control devices. The communicator 110 may be achieved by a communication module for well-known short-range wireless communication such as Bluetooth, infrared (IR), ultra wideband (UWB), Zigbee, etc., or by a well-known communication port for wireless communication. The communicator 110 may be utilized for various purposes, for example, transmitting/receiving a command and data for operating a displayer or display in addition to the control signal for selecting a user interface (UI).

There is no limit to the kinds of image processing performed by the image processor 120. For example, the image processing may include decoding corresponding to an image format of image data, de-interlacing for converting interlace-type image data into progressive type data, scaling for adjusting the image data to have a preset resolution, noise reduction for improving image quality, detail enhancement, frame refresh rate, conversion, etc.

The image processor 120 may be achieved by a system-on-chip (SOC) where many functions are integrated, or an image processing board (not shown) where individual elements for independently performing such processes are mounted on a printed circuit board, and built into the display apparatus 1.

The image processor 120 performs various image processes previously set with regard to a broadcasting signal including the image signal received from the receiver (not shown), and a source image including the image signal received from an image source (not shown). The image processor 120 outputs an image signal produced by such processes to the display apparatus 1, so that the processed source image can be displayed on the display apparatus 1.

The displayer or display 130 may display an image based on the image signal output from the image processor 120. There is no limit to the type of the displayer 130. For example, the displayer 130 may be achieved by various display types such as liquid crystal, plasma, a light-emitting diode, an organic light emitting diode, a surface-conduction electron-emitter, a carbon nano-tube, nano-crystal, etc.

The displayer 130 may include an additional element in accordance with its types. For example, if the displayer 130 is a liquid crystal type, the displayer 130 may include a liquid crystal display panel (not shown), a backlight unit for emitting light to the panel, and a panel driving substrate (not shown) for driving the panel (not shown).

The displayer 130 displays an image based on the image signal processed by the image processor 120. There is no limit to the types of the displayer 130 for displaying an image. For example, the type of the displayer 130 may include an LCD, a PDP, an OLED, etc. In this case, the displayer 130 may include an LCD panel, panel, a PDP panel, an OLED panel, etc.

The displayer 130 may display an image and a color calibration process. The displayer 130 may include a display panel on which an image is displayed, and a panel driver to process an input image signal to be displayed as an image on the display panel, of which detailed operations are not limited. The image signal received from an external (input) source through the interface may experience the image processing such as decoding, de-interlacing, scaling, etc. and be displayed on the displayer 130.

The storage 140 may be achieved by a nonvolatile memory (e.g., a writable read only memory (ROM)) that maintains data even though the display apparatus 1 is powered off, and reflects a user's change thereon. That is, the storage 140 may be provided as one of a flash memory, an erasable programmable read only memory (EPROM), an electrically erasable and programmable read only memory (EEPROM). The storage 140 may store login information about a plurality of accounts and about a group account corresponding to the plurality of accounts.

The controller 100 logs in with the plurality of accounts using the login information about the plurality of accounts corresponding to the group account when the group account logs in to produce a plurality of logged-in accounts, and controls the displayer 130 to display the processed image of an account service corresponding to the plurality of logged-in accounts.

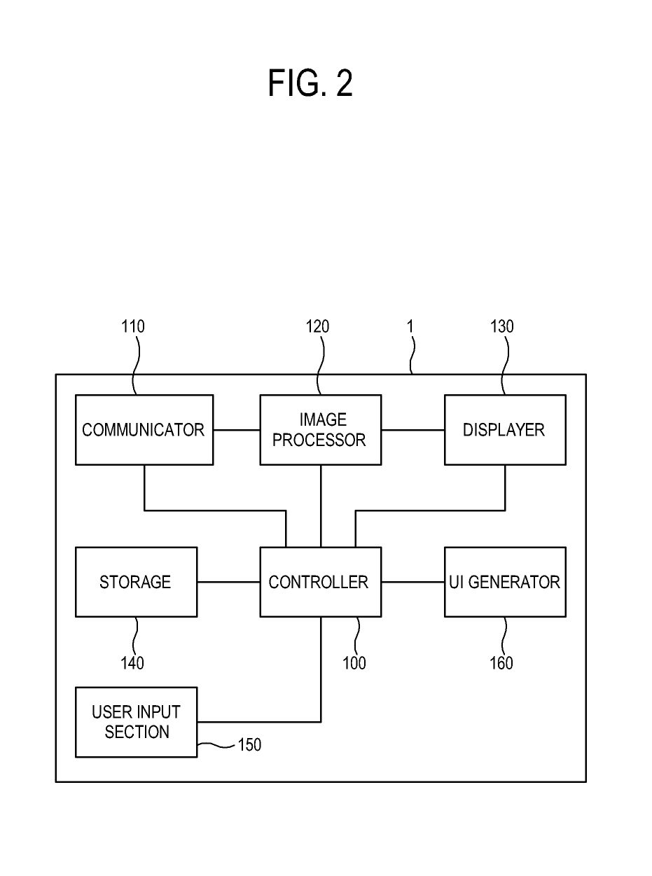

FIG. 2 is a specific block diagram of display apparatus according to an exemplary embodiment. According to an exemplary embodiment, the display apparatus 1 may include elements shown in FIG. 1, and additionally include a user input section 150, and a user interface (UI) generator 160.

The user input section 150 transmits various control commands or information preset in accordance with a user's operations or inputs to the controller 100. The user input section may be achieved by a menu-key or input panel installed at an outside of the display apparatus 1, a remote controller provided separately and remotely from a user terminal, etc. Further, the user input section 150 may be integrated into the displayer 130. If the displayer or display 130 is achieved by a touch screen, a user touches an input menu (not shown) displayed on the displayer 130 so that a preset command can be transmitted to the controller 100.

The user input section 150 receives a user's motion. The user's motion includes a touch input. The user input section 150 may receive the user's motion directly, or receive information about the user's motion from an external device.

The UI generator 160 may generate a UI for operating an executed application program. The generated UI includes a plurality of sub UIs provided in the form of an icon, a text, etc. If a user selects certain sub UIs through the display apparatus 1, an application program may run in response to the selected sub UI. That is, each sub UI may be generated by a plurality of function or event units for running the application program executed in the display apparatus 1.

The UI generator 160 refers to a software or hardware function to generate and control the UI displayed on the displayer 130, and the function may be performed by the controller 100 to be described later. In other words, the UI generator 160 may be achieved by not using a separate chipset or microprocessor different from that of the controller 100.

In the display apparatus 1 according to an exemplary embodiment, the plurality of accounts refers to accounts of users corresponding to the accounts.

Also, the login information may include at least one among an account address, an account ID, an account password, a certification password, and a phone number of a corresponding user.

The controller 100 may control the account to be one of added to, deleted from and edited in the group account. It is possible for a user to set up the account to be set as the group account. For example, “a father account”, “a mother account”, and “a son account” may be set as the group account. The group account may be stored in the storage 140 by setting an individual account such as “the father account”, “the mother account” and “the son account”, the account address, the account ID, the account password, the certification password, the phone number, etc.

When the group account logs in the state that at least one another account that does not correspond to the group account is logged in, the controller 100 may select the logged-in another account to log out in response to a user's input. For example, if the group account logs in when an account not in the group account logs in before the group account logs in, a user selects whether to allow additional login, thereby making the account not the group account log in, or making the group account log in while maintaining the login of the account not in the group account.

If at least one another account that does not correspond to the group account logs in while the group account is logged in, the controller 100 may add the logged-in another account to the group account in accordance with a user's input. If a user selects the another account to be added to the group account, a setting UI is immediately generated for performing addition to the group account. When the login of all the accounts is maintained and logged out, the addition to the group account may be performed through the setting UI. Also, when at least one another account that does not correspond to the group account logs in, the controller 100 sets up the login information to be stored and automatically performs the addition to the group account without generating the setting UI if the logged-in another account is added to the group account.

The controller 100 may make all the accounts of the group account be logged out if the group account is logged out. When the group account is logged out, the controller 100 makes the plurality of accounts corresponding to the group accounts be respectively logged out. Also, if the group account logs out in the state that the group account and at least one another account that does not correspond to the group account are being logged in, the controller 100 may select the logged-in another account to be logged out in accordance with a user's input. In this case, if the logout of the logged-in another account is not selected, only the accounts corresponding to the group account are logged out. If the logged-in another account is added to the group account, the addition, deletion or editing may be applied to the group account.

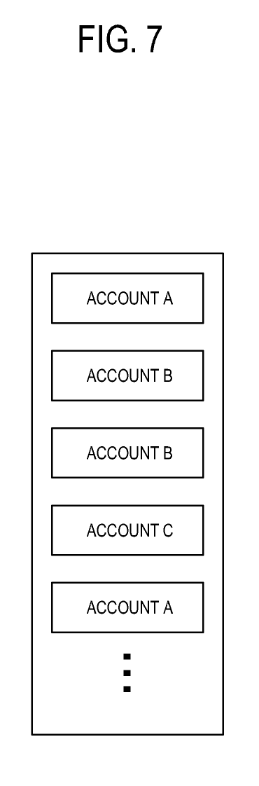

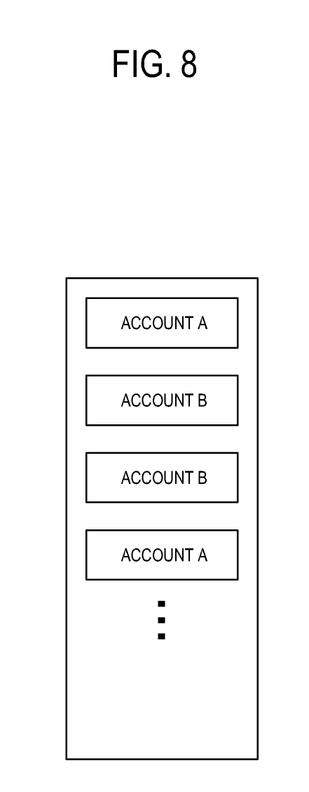

The controller 100 may combine and display the images of the account services corresponding to the plurality of logged-in accounts. As shown in FIGS. 7 and 8, the display apparatus 1 according to an exemplary embodiment may combine and display the images of the account services as an example of a screen on which the account service information is displayed.

FIG. 7 shows an example of a screen on which time combination service information is displayed as combination service information in which account service information of an account A, an account B and an account C are combined.

That is, as shown in FIG. 7, time combination service information is displayed as items corresponding to respective user accounts are combined in one common time line in order of time.

FIG. 8 shows an example of a screen on which another combination service information is displayed according to an exemplary embodiment.

That is, as shown in FIG. 7, if the account C is logged out or the account excluding command for a user C is input in the state that the account service information corresponding to the account A, the account B and the account C is displayed, the items corresponding to the account C are excluded and the combination service information including only the items corresponding the account A and the account B is displayed.

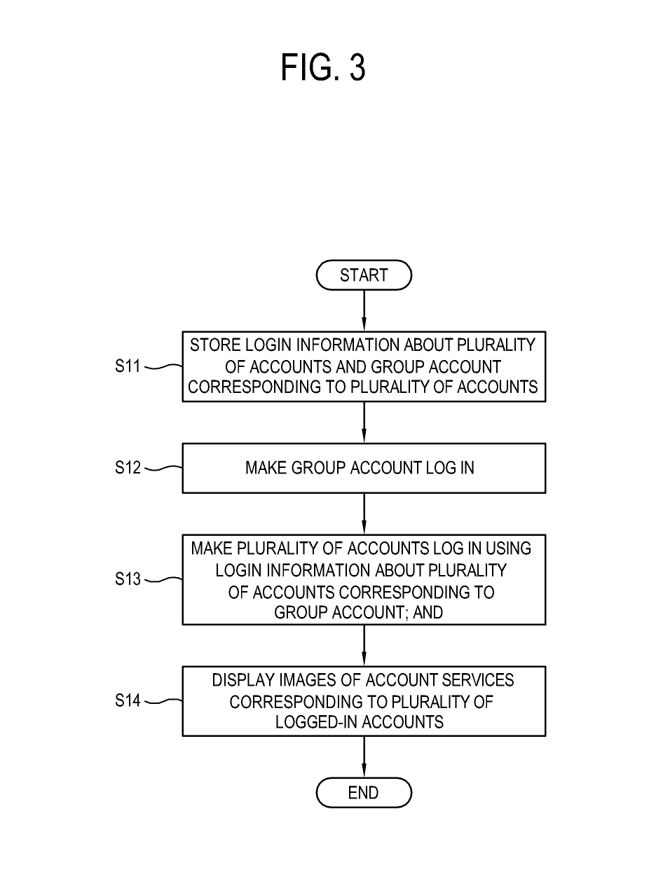

FIG. 3 is a control flowchart showing operations of the display apparatus 1 according to an exemplary embodiment.

The login information about the plurality of accounts and the group account corresponding to the plurality of accounts is stored (S11).

The group account is logged in (S12).

Using the login information about the plurality of accounts stored corresponding to the group account, the plurality of accounts logs in (S13).

The image of the account service corresponding to the plurality of logged-in accounts is displayed (S14).

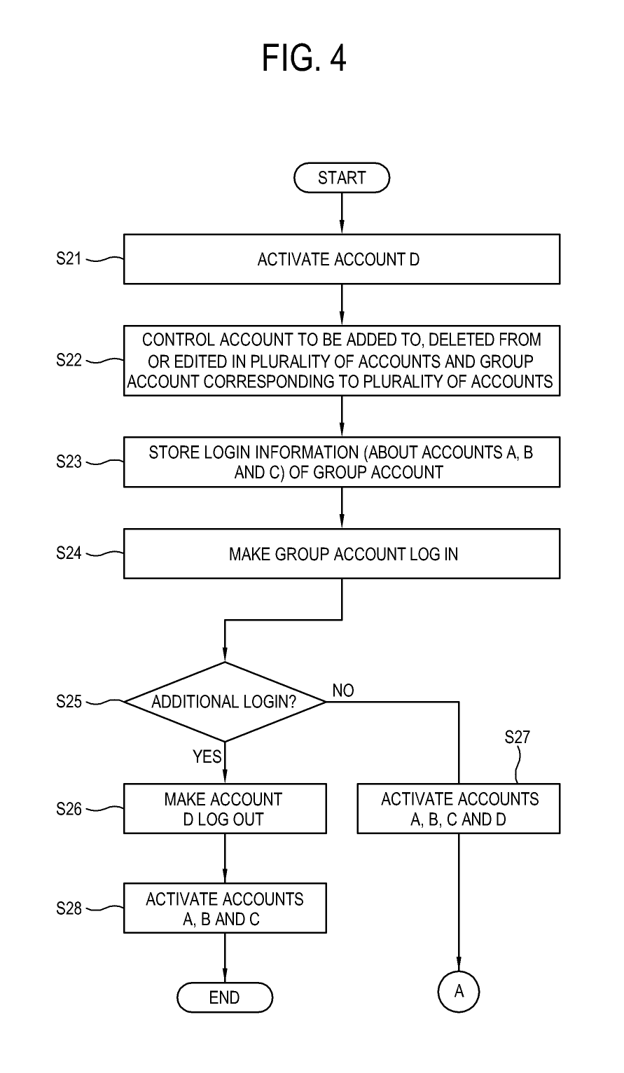

FIG. 4 is a control flowchart showing operations of the display apparatus 1 according to an exemplary embodiment.

A user logs in with an account D and activates the account D (S21).

An account is added to, deleted from or edited in the plurality of accounts and the group account corresponding to the plurality of accounts (e.g., the accounts A, B and C) (S22).

The login information about the accounts A, B and C set up as the group account is stored (S23).

The group account is logged in (S24).

A user selects whether to make additional login together with the activated account D (S25).

If the group account is selected to additionally log in, the accounts A, B and C of the group account are activated so that all the account A, B, C and D can be activated (S27).

If the additional login is not selected in the operation S25, the account D is logged out (S26).

Then, the accounts A, B and C of the group account are activated (S28).

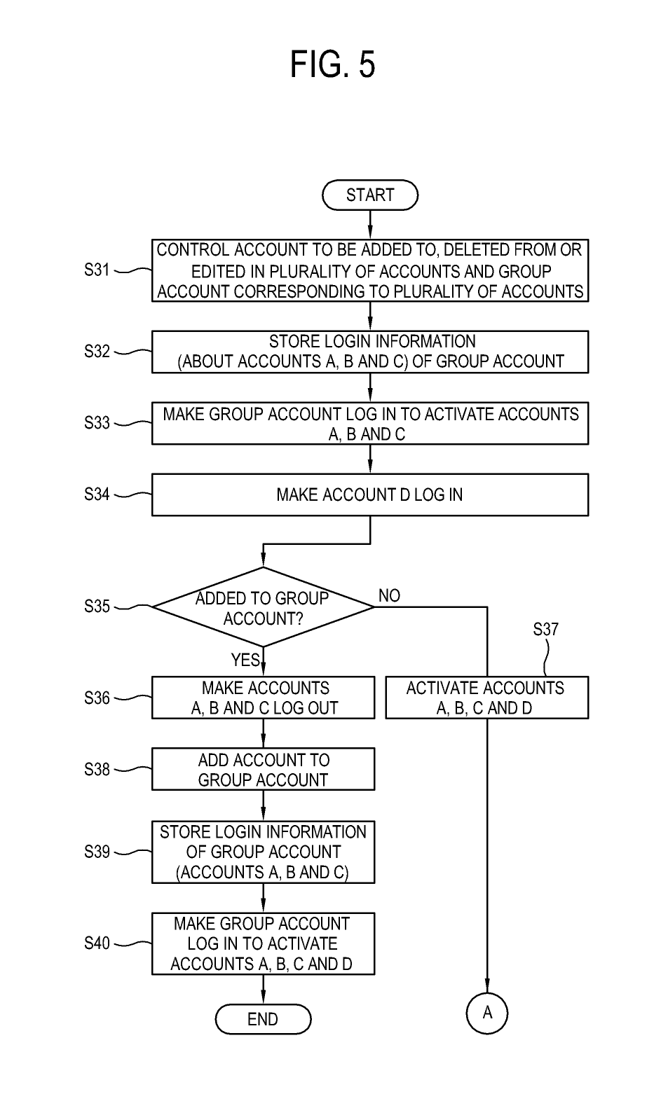

FIG. 5 is a control flowchart showing operations of the display apparatus 1 according to an exemplary embodiment.

The account is added to, deleted from or edited in the plurality of accounts and the group account corresponding to the plurality of accounts (e.g., the accounts A, B and C) (S31).

The login information about the accounts A, B and C set up as the group account is stored (S32).

The group account is logged in to activate the accounts A, B and C (S33).

The account D is logged in (S34).

A user selects whether to add the account D to the group account (S35).

If the account D is not selected to be added to the group account, the account D is activated so that the accounts A, B, C and D can be activated (S37).

If the account D is selected to be added to the group account in the operation S35, the accounts A, B and C are logged out (S36).

The account D is added to and set up as the group account (S38).

The login information about the account A, B, C and D set up as the group account is stored (S39).

The group account is logged in to activate the accounts A, B, C and D (S40).

Here, in the operations S36, S38 and S39, the account D may be added to the group account and performed when the group account is logged out. Then, the operation S40 is performed when the group account is logged in.

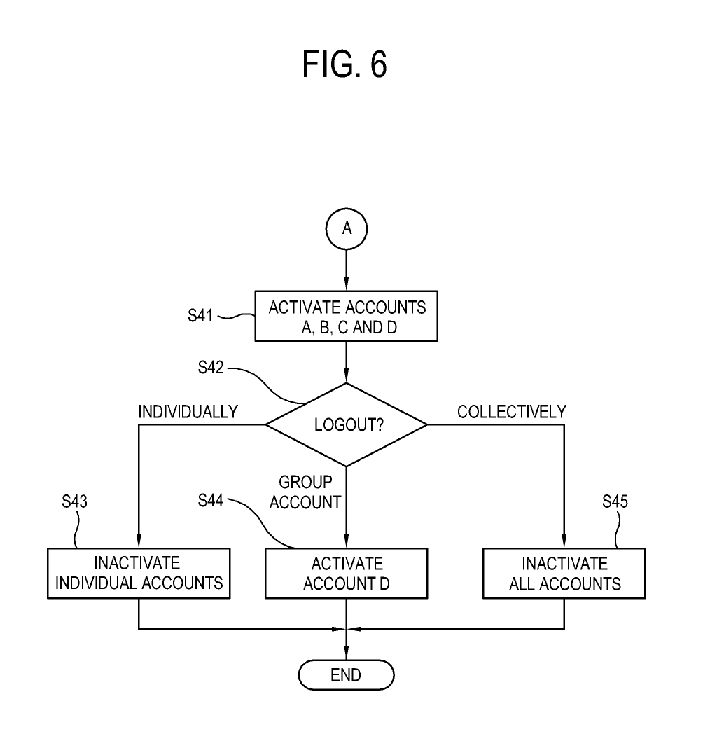

FIG. 6 is a control flowchart showing operations of the display apparatus 1 according to an exemplary embodiment.

FIG. 6 shows a process where the group account is logged out in the state that the accounts A, B and C of the group account and the account D are activated as shown in FIGS. 4 and 5.

The accounts A, B, C and D are activated (S41).

When the group account is logged out, a user selects one among three cases of individual logout, collective logout, and group-account logout.

If the individual logout is selected, it is individually determined whether to make the accounts A, B, C and D log out, thereby making the accounts individually log out and be inactivated (S43).

If the collective logout is selected, all the accounts A, B, C and D are logged out and inactivated (S45).

If only the group account is logged out, the accounts A, B and C of the group account are simultaneously logged out and inactivated to thereby activate only the account D (S44).

In the foregoing display apparatus 1, the login information about the plurality of accounts and the group account corresponding to the plurality of accounts is stored; and when the group account is logged in, the plurality of accounts log in using the login information of the plurality of corresponding accounts, and an image of an account service corresponding to the plurality of logged-in accounts is displayed, thereby allowing multi-accounts to quickly log in/out through simultaneous login/logout of multiple accounts under the condition that multi-login is possible in the display apparatus 1 used by multiple users.

According to an exemplary embodiment, multi-accounts can be quickly logged in/out through simultaneous login/logout of multiple accounts under the condition that multi-login is possible in the display apparatus 1 used by multiple users.

Although a few exemplary embodiments have been shown and described, it will be appreciated by those skilled in the art that changes may be made in these exemplary embodiments without departing from the principles and spirit of the embodiments. Therefore, the foregoing has to be considered as illustrative only. The scope of the embodiments is defined in the appended claims and their equivalents. Accordingly, all suitable modification and equivalents may fall within the scope of the embodiments.

The processes discussed herein may be stored on media and performed by program instructions. Examples of computer-readable media or processor-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer or processor using an interpreter.

The described hardware devices may also be configured to act as one or more software modules in order to perform the operations of the above-described. Any one or more of the software modules described herein may be executed by a dedicated processor unique to that unit or by a processor common to one or more of the modules.

What is claimed is:

1. A display device, comprising:
a communicator configured to communicate with at least one external server that offers an account service;
a storage configured to store login information about a plurality of accounts and a group account corresponding to the plurality of accounts;
an image processor configured to process an image of the account service to produce a processed image;
a display configured to display the processed image; and
a controller configured to make the plurality of accounts log in using the login information about the plurality of accounts corresponding to the group account when the group account logs in to produce a plurality of logged-in accounts, and control the display to display the processed image of the account service corresponding to the plurality of logged-in accounts.

2. The display apparatus according to claim 1, wherein the plurality of accounts comprises accounts of users corresponding to the accounts.

3. The display apparatus according to claim 1, wherein the login information comprises at least one among an account address, an account identification (ID), an account password, a certification password, and a phone number of a corresponding user.

4. The display apparatus according to claim 1, wherein the controller controls an account to be one of added to, deleted from and edited in the group account.

5. The display apparatus according to claim 1, wherein the controller selects whether to make at least one logged-in another account be logged out in accordance with a user input if the group account logs in while the at least one another account that does not correspond to the group account is logged in.

6. The display apparatus according to claim 1, wherein the controller adds at least one another account to the group account in accordance with a user input if the at least one another account that does not correspond to the group account is logged in while the group account is logged in.

7. The display apparatus according to claim 1, wherein the controller makes all accounts of the group account be logged out if the group account is logged out.

8. The display apparatus according to claim 1, wherein the controller makes the plurality of accounts be individually logged out when the group account is logged out.

9. The display apparatus according to claim 1, wherein the controller selects whether to make at least one logged-in another account be logged out in accordance with a user input if the group account logs out while the group account and the at least one another account that does not correspond to the group account are logged in.

10. The display apparatus according to claim 1, wherein the controller controls images of account services corresponding to the plurality of logged-in accounts to be combined and displayed.

11. A method of controlling a display apparatus, the method comprising:
storing login information about a plurality of accounts and a group account corresponding to the plurality of accounts;
making the group account log in;
making the plurality of accounts log in using the login information about the plurality of accounts corresponding to the group account; and
displaying an image of an account service corresponding to the plurality of logged-in accounts.

12. The method according to claim 11, wherein the plurality of accounts comprises accounts of users corresponding to the accounts.

13. The method according to claim 11, wherein the login information comprises at least one among an account address, an account identification (ID), an account password, a certification password, and a phone number of a corresponding user.

14. The method according to claim 11, wherein the storing the login information comprises controlling an account to be one of added to, deleted from and edited in the group account.

15. The method according to claim 11, further comprising selecting whether to make at least one logged-in another account be logged out in accordance with a user input if the group account logs in while the at least one another account that does not correspond to the group account is logged in.

16. The method according to claim 11, wherein the making the plurality of accounts log in comprises adding at least one another account to the group account in accordance with a user input if the at least one another account that does not correspond to the group account logs in while the group account is logged in.

17. The method according to claim 11, further comprising making all accounts of the group account be logged out if the group account is logged out.

18. The method according to claim 11, further comprising making the plurality of accounts be individually logged out when the group account is logged out.

19. The method according to claim 11, further comprising selecting whether to make at least one logged-in another account be logged out in accordance with a user input if the group account logs out while the group account and the at least one another account that does not correspond to the group account are logged in.

20. The method according to claim 11, wherein the displaying the image comprises controlling images of account services corresponding to the plurality of logged-in accounts to be combined and displayed.

21. A method, comprising:
simultaneously logging-in all accounts of a group account when the group account logs-in, and simultaneously logging-out all accounts of the group account when the group account logs-out, and producing account service information for each of the accounts at a time of log-in and log-out; and
displaying account service status information for each of the accounts.

22. A method as recited in claim 21, wherein the group account is one of the accounts of the group.

23. A display apparatus, comprising:
a processor logging-in all accounts of a group account when the group account logs-in and producing account service information for each of the accounts logged-in; and
a display simultaneously displaying the account service information for each of the accounts logged-in.

24. An apparatus as recited in claim 23, wherein the account service information depicts a time line showing account log-in order.

25. An apparatus according to claim 23, further comprising a storage storing group account identification and account identification information for each of the accounts of the group, and wherein the processor retrieves the account identification information for each of the accounts of the group when the group account identification is received and collectively logs-in the accounts of the group.

26. An apparatus according to in claim 23, wherein if another account is logged-in when the group account logs-in the processor, responsive to a user selection, one of:
logs out the another account; and
includes the another account in the group account and updates the account identification information of the group with identification information of the another account.
